(19) United States
(12) Patent Application Publication
(10) Pub. No.: US 2017/0240692 A1
(43) Pub. Date: Aug. 24, 2017

(54) MODIFIER FOR CURABLE COMPOSITIONS COMPRISING BENZYL ALCOHOL ALKOXYLATES

(71) Applicant: Evonik Degussa GmbH, Essen (DE)

(72) Inventors: Katrin Roland, Essen (DE); Matthias Lobert, Essen (DE); Jürgen Kirchner, Essen (DE); Ellen Reuter, Bochum (DE)

(21) Appl. No.: 15/429,471

(22) Filed: Feb. 10, 2017

(30) Foreign Application Priority Data
Feb. 19, 2016 (EP) 16156475.2

(51) Int. Cl. C08G 59/68; C09D 163/00

(52) U.S. Cl. CPC C08G 59/68; C09D 163/00

(57) ABSTRACT

The present invention relates to a modifier comprising benzyl alcohol-based alkoxylates for curable compositions comprising at least one epoxy resin and a hardener, which are obtained by reacting benzyl alcohol with alkylene oxides, the benzyl alcohol-based alkoxylates having at least one ethoxy fragment.

The present invention relates to a modifier comprising benzyl alcohol-based alkoxylates for curable compositions comprising at least one epoxy resin and a hardener, to the use thereof and to curable compositions comprising said modifier.

Epoxy resins are known raw materials for the production of high-quality casting resins and coating materials. The reaction of these resins with a number of hardeners, especially with aminic hardeners, leads to crosslinked polymers that can be thermoset polymers and can be used in the fields of, for example, civil engineering, particularly in industrial floors, seals and concrete restoration products, composites (fiber composite materials), potting compounds, paints and adhesives. An overview of resins and hardeners, including their properties, and the use thereof in the field of civil engineering may be found in H. Schuhmann, “Handbuch Betonschutz durch Beschichtungen” [Handbook of Concrete Protection using Coatings], Expert Verlag 1992, pp. 396-428. The use of resins and hardeners in the field of composites is described in P. K. Mallick, “Fiber-Reinforced Composites, Materials, Manufacturing, and Design”, CRC Press, pp. 60-76.

As well as epoxy resins and hardeners, a standard curable composition typically also comprises reactive diluents and non-reactive constituents, for example catalysts, additives, plasticizers, extenders or modifiers. These constituents on the one hand have a positive effect on the reactivity and levelling of the composition, but on the other hand the environment can be polluted by continuous evaporation of non-reactive constituents not incorporated into covalent bonds after conclusion of the hardening.

A long-established modifier is benzyl alcohol. Benzyl alcohol is miscible both with the epoxy resin and with the amine hardener and has a viscosity-reducing and hence levelling-promoting effect. Furthermore, benzyl alcohol catalyzes the curing reaction of aminic hardeners and epoxy resins. Moreover, benzyl alcohol suppresses unwanted carbamate formation, which is an accompanying side reaction of the amine with the carbon dioxide from the ambient air.

For the utilization of benzyl alcohol in epoxy resin coatings, marked restrictions are to be expected in the future. These arise, inter alia, from various national and international guidelines (EU Decopaint guideline) for limitation of VOC (volatile organic compound) emissions from coating materials and for reduction of the health risk to the processor and user by volatile and semi-volatile compounds (VOCs and SVOCs) (see demands of the Ausschuss fur die gesundheitliche Bewertung von Bauprodukten=AgBB [German Committee for Health-related Evaluation of Building Products]) or the certification of buildings according to the Deutsche Gesellschaft fur Nachhaltiges Bauen e. V. (DGNB) [German Sustainable Building Council] or Leadership in Energy & Environmental Design (LEED).

This gives rise to a high demand for the development of novel epoxy systems that are free of benzyl alcohol.

The prior art discloses some approaches to a solution in respect of this objective.

The German review article “Ohne Benzylalkohol geht's auch” [Doing without Benzyl Alcohol] from Farbe and Lacke, 2010, 3, mentions some auxiliaries, for example specific polyamidoamine hardeners, specific low-viscosity high-boiling resins or else high-boiling glycol ethers, in order to formulate a curable composition without benzyl alcohol. It is possible in principle to use auxiliaries, but this is associated with a lot of complexity and high costs.

EP 2706076 B1 discloses benzyl alcohol-free epoxy resin-based compositions having a tailored furfurylamine-based hardener. However, the complex process for preparation thereof makes it more expensive than standard aminic hardeners. As well as the economic aspect, it is certainly made more difficult for these “special” amine hardeners to make the commercial breakthrough because the amine hardener in established systems cannot simply be exchanged.

Benzyl alcohol-based alkoxylates are known to those skilled in the art. For instance, benzyl glycols are described in WO 2005026275 and U.S. Pat. No. 8,129,032 B2 as additive in aqueous dispersions. Use as dispersant for color pigments (JP4787416 B2, US 20060001011) or as emulsifier in aqueous epoxy-based dispersions (JP 60019774 B, JP 60011728 B and JP 51033940 B) is also known.

Benzyl alcohol-based propoxylates are described in WO 9937714 A1 in the context of solvent-containing and solvent-free epoxy resin systems. Phenol-based and benzyl alcohol-based propoxylates are described therein as plasticizer for epoxy resin and amine hardener. If such alkoxylates are used as a substitute for benzyl alcohol in curable compositions, the gel time is extended, leaving the surface hardness of the hardened material virtually unaffected after 5 d.

It is therefore desirable to provide a modifier for curable epoxy resin-based compositions, wherein these curable compositions have a reduction in the VOC (volatile organic content) and SVOC (semi-volatile organic content) values compared to comparable benzyl alcohol-containing curable epoxy resin-based compositions, and at the same time do not show any significant deterioration in the processing-relevant properties of the curable composition.

To solve the problem, a modifier of the type mentioned at the outset is proposed, wherein the benzyl alcohol-based alkoxylate is obtained by reacting benzyl alcohol with alkylene oxides and has at least one ethoxy fragment.

A modifier is understood in the context of this invention to mean the following: It is an important constituent in a curable composition that has a positive effect on the reactivity and levelling of the composition. In the broadest sense, the modifier of the invention is to represent the same function as the benzyl alcohol known from the prior art for this purpose. Benzyl alcohol is miscible both with the epoxy resin and with the amine hardener and has a viscosity-reducing and hence levelling-promoting effect. Furthermore, benzyl alcohol catalyzes the curing reaction and the conversion of aminic hardeners and epoxy resins. The unwanted formation of carbamate, as a side reaction of the unconverted amine with the carbon dioxide from the ambient air, is thus counteracted by the use of benzyl alcohol.

It has now been found that the curable composition produced with the modifier according to the invention has lower outgassing characteristics than curable compositions comprising benzyl alcohols.

The outgassing characteristics are inferred on the basis of the volatile content up to a boiling point of 365° C. Up to this range, the volatile constituents (VOCs) and semi-volatile constituents (SVOCs) are recorded as a cumulative parameter. The lower the percentage, the lower the level of volatile substances that are released into the environment. The volatile fractions were determined by gas chromatography to DIN EN ISO 11890-2. 365° C. is the limit for the SVOC (semi-volatile organic content).

It has likewise been found that, surprisingly, the modifier according to the invention, with regard to the processing-relevant properties, for example dilution effect, viscosity reduction and hardening reaction, does not have any significant deterioration compared to the standard benzyl alcohols.

Compared to benzyl alcohol-based propoxylates, the modifier according to the invention additionally shows an improvement in at least one processing-relevant property for the same alkoxy fragment chain length.

In the case of use of the curable compositions according to the invention, curable composition comprising the modifier according to the invention, it was especially possible to detect a distinct improvement in the reduction in viscosity compared to the use of the benzyl alcohol-based propoxylates. Likewise recorded were quicker hardening, better flowability and a lower tendency to carbamate formation in the curable compositions.

Where chemical (empirical) formulae are used in the present invention, the specified indices may be not only absolute numbers but also average values.

The indices relating to polymeric compounds are preferably average values.

Unless stated otherwise, percentages are figures in percent by weight.

If measured values are reported hereinbelow, these measurements, unless stated otherwise, have been conducted under standard conditions (25° C. and 1013 mbar).

When average values are reported hereinbelow, the values in question are weight averages, unless stated otherwise.

Preferably, the benzyl alcohol-based alkoxylates according to the invention are benzyl alcohol-based ethoxylates.

Preferably, the benzyl alcohol-based alkoxylates according to the invention are benzyl alcohol-based mixed alkoxylates of the formula (I):

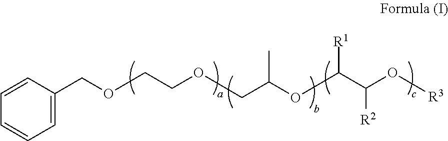

where
a=alkoxy fragment (a)=1 to 10, preferably 2 to 7, especially preferably 3 to 6,
b=alkoxy fragment (b)=0 to 10, preferably 1 to 7, especially preferably 1 to 5,
c=alkoxy fragment (c)=0 to 10, preferably 0 to 6, especially preferably 0 to 3,
R1, R2=independently hydrogen, an alkyl group having 2 to 20 carbon atoms, an aryl or alkaryl group, preferably an ethyl, octyl, decyl, phenyl, especially preferably ethyl or phenyl, with the proviso that R1 is not H when R2 is methyl, and that the two R1 and R2 radicals must not both be H at the same time,
R3=independently a hydrogen radical, an acetyl, phosphoric ester or alkyl group which has 1 to 20 carbon atoms and may also have further substitution, preferably an acetyl, methyl or phosphoric ester group or a hydrogen radical, more preferably a hydrogen radical.

Preferably, the modifier according to the invention is prepared by reaction of benzyl alcohol with alkylene oxides.

Benzyl alcohol (CAS: 100-51-6) is an aromatic alcohol also known by the chemical names of phenylmethanol and phenylcarbinol. It is a natural raw material present to an extent of about 6% in jasmine blossom oil, but also in clove oil or wallflower oil.

It is generally possible to use all alkylene oxides known to those skilled in the art. Preference is given to using, for example, ethylene oxide (EO), propylene oxide (PO), 1,2-epoxy-2-methylpropane (isobutylene oxide), epichlorohydrin, 2,3-epoxy-1-propanol, 1,2-epoxybutane (butylene oxide, also abbreviated hereinafter as BO), 2,3-epoxybutane, 2,3-dimethyl-2,3-epoxybutane, 1,2-epoxypentane, 1,2-epoxy-3-methylpentane, 1,2-epoxyhexane, 1,2-epoxycyclohexane, 1,2-epoxyheptane, 1,2-epoxyoctane, 1,2-epoxynonane, 1,2-epoxydecane, 1,2-epoxyundecane, 1,2-epoxydodecane, styrene oxide (also abbreviated hereinafter as SO), 1,2-epoxycyclopentane, 1,2-epoxycyclohexane, vinylcyclohexene oxide, (2,3-epoxypropyl)benzene, vinyloxirane, 3-phenoxy-1,2-epoxypropane, 2,3-epoxy methyl ether, 2,3-epoxy ethyl ether, 2,3-epoxy isopropyl ether, 3,4-epoxybutyl stearate, 4,5-epoxypentyl acetate, 2,3-epoxypropane methacrylate, 2,3-epoxypropane acrylate, glycidyl butyrate, methyl glycidate, ethyl 2,3-epoxybutanoate, 4-(trimethylsilyl)butane 1,2-epoxide, 4-(triethylsilyl)butane 1,2-epoxide, 3-(perfluoromethyl)-1,2-epoxypropane, 3-(perfluoroethyl)-1,2-epoxypropane, 3-(perfluorobutyl)-1,2-epoxypropane, 3-(perfluorohexyl)-1,2-epoxypropane, 4-(2,3-epoxypropyl)morpholine, 1-(oxiran-2-ylmethyl)pyrrolidin-2-one.

All the alkylene oxides mentioned can be used individually or in any desired mixtures for alkoxylation of the benzyl alcohol.

Particular preference is given to using ethylene oxide, propylene oxide, butylene oxide and styrene oxide.

In order, for example, to introduce the alkoxy fragments (a) and (b) shown in formula (I) into the modifier according to the invention, it is possible with preference to use ethylene oxide (EO) for the alkoxy fragment (a) and to use propylene oxide (PO), also known by the 1,2-epoxypropane name, for the alkoxy fragment (b).

In order, for example, to introduce the alkoxy fragments (c) specified in formula (I) into the modifier according to the invention, it is possible with preference to use butylene oxide (BO) and/or styrene oxide (SO) for the alkoxy fragment (c).

In a very particularly preferred embodiment, ethylene oxide and propylene oxide are used in a molar ratio of 1:10 to 10:0, preferably of 3:1 to 1:0, more preferably 3:3, 3:1, 4:0 or 1:1.

The alkoxy fragments (a), (b) and (c) may preferably have a statistical distribution and/or blockwise distribution.

The required distribution of the alkoxy fragments (a) and/or (b) and/or (c) can be achieved via the particular process regime known to those skilled in the art, more particularly via the addition sequence or the simultaneous addition of the respective alkylene oxides (individually or as a mixture) and via their molar ratio to one another.

The alkoxylation of the benzyl alcohol can be effected under base, acid, or transition metal catalysis. The alkoxylation is preferably conducted in the presence of double metal cyanide (DMC) catalysts or bases. Particular preference is given to conducting the alkoxylation in the presence of bases.

The base-catalyzed alkoxylation of benzyl alcohol is preferably conducted at least partly with alkali metal hydroxide or alkoxide, preferably sodium methoxide, potassium methoxide or potassium hydroxide, more preferably potassium methoxide or potassium hydroxide. The amount of alkali metal hydroxides or alkoxides used is preferably from 1 to 15 mol %, more preferably from 1.5 to 10 mol %, especially preferably 2 to 7 mol %.

The alkoxylation is preferably conducted at a temperature between 80° C. and 200° C., preferably from 90 to 170° C. and more preferably from 100 to 125° C. The conversion is preferably effected at pressures in the range from 0.001 to 100 bar, more preferably in the range from 0.005 to 10 bar and most preferably from 0.01 to 5 bar (each absolute pressures). If necessary, the alkoxylation can also be conducted in the presence of an inert gas (for example nitrogen).

The terminal hydroxyl groups of the benzyl alcohol alkoxylates may preferably remain in free form or may be modified partly or completely in order to optimize compatibility in the later application matrix.

Accordingly, the benzyl alcohol-based alkoxylate preferably has a terminal hydroxyl group.

Conceivable modifications are transesterifications, esterifications or etherifications, as are further condensation or addition reactions with isocyanates, for example, which can be conducted by any desired prior art methods.

Preferably, the terminal hydroxyl groups are acetylated, methylated or phosphorylated, more preferably phosphorylated.

Preferably, the degree of alkoxylation is 3 to 10, more preferably 4 to 8.

The polydispersity (Mw/Mn) of benzyl alcohol alkoxylates of the formula (I), determined by means of GPC, is preferably <2.5, more preferably <2.0 and especially preferably from >1.05 to <1.5.

The invention further provides for the use of benzyl alcohol-based alkoxylates, wherein the benzyl alcohol-based alkoxylate has at least one epoxy fragment as modifiers for curable compositions comprising at least one epoxy resin, at least one hardener, preferably an aminic hardener or an acidic hardener, and optionally further auxiliary components.

Preference is given to using the inventive benzyl alcohol-based alkoxylates of formula (I) as modifiers.

The inventive benzyl alcohol alkoxylates of the formula (I) can be used for various applications.

The present invention likewise provides curable compositions comprising

(1) at least one epoxy resin,
(2) at least one hardener (2a) of aminic nature or (2b) of acidic nature,
(3) at least one modifier of formula (I),
(4) optionally further auxiliary components.

Epoxy resins used, component (1) of the curable compositions, may in principle be any epoxy resins that can be hardened with amines. Essentially, epoxy resins are prepolymers containing two or more epoxy groups per molecule. The most commonly used are bisphenol-based glycidyl ethers or novolaks, usually having viscosities of greater than 10 Pa*s.

Examples include bisphenol A diglycidyl ether, bisphenol F diglycidyl ether or cycloaliphatic types, for example 3,4-epoxycyclohexylepoxymethane or 3,4-epoxycyclohexylmethyl 3,4-epoxycyclohexanecarboxylate.

Preference is given to using bisphenol A-based epoxy resins and bisphenol F-based epoxy resins in the composition according to the invention.

Aminic hardeners used, component (2a) of the curable compositions, are typically aliphatic, cycloaliphatic, araliphatic or aromatic amines or polyamines. Preference is given to using amine-containing hardeners having at least two or more primary and/or secondary amino groups. Examples of aliphatic amines include diaminoethane, diaminopropane, diaminobutane, neopentanediamine, diaminohexane, and also bis(aminocyclohexyl)methane, diaminocyclohexane, 3,3′-dimethyl-4,4′-diaminodicyclohexylmethane, tricyclododecanediamine, norbornanediamine, TCD-diamine, N-aminoethylpiperazine, isophoronediamine, 1,3- and/or 1,4-bis(aminomethyl)cyclohexane, trimethylhexamethylenediamine, N-aminoethylpiperazine, 1,4-bis(aminopropyl)piperazine.

Aromatic amines used may preferably be methylenedianiline, xylylenediamine, m-phenylenebis(methylamine). Polyetheramines used may advantageously be polyoxyalkyleneamines such as diethylenetriamine, triethylenetetramine, tetraethylenetetramine, etc., and also dipropylenetriamine, tripropylenetetramine, polyaminoamides, and reaction products of amines with acrylonitrile and Mannich bases.

Acidic hardeners used, component (2b) of the curable composition, are typically acids and acid anhydrides. Preference is given to using carboxylic anhydrides or polymeric carboxylic anhydrides, or resins or polymers containing carboxylic anhydrides. Examples include phthalic anhydride, tetrahydrophthalic anhydride, hexahydrophthalic anhydride, methyltetrahydrophthalic anhydride, 3,6-endomethylenetetrahydrophthalic anhydride, hexachloroendomethylenetetrahydrophthalic anhydride, methyl-3,6-endomethylenetetrahydrophthalic anhydride, trimellitic anhydride, maleic anhydride, acrylic anhydride, methacrylic anhydride, hydroxymethylacrylic anhydride, hydroxyethylacrylic anhydride, hydroxypropylacrylic anhydride.

The modifier used, component (3) of the curable compositions, may preferably be a compound of the formula (I).

Auxiliary components used, component (4) of the curable compositions, may be any component that has a positive effect on the properties of the composition according to the invention. It is independently possible to add one or more auxiliary components.

Listed hereinafter are some auxiliary components that can be used for the curable composition according to the invention. The enumeration is non-conclusive.

Auxiliary components usable advantageously are, for example, reactive diluents. The term “reactive diluent” is understood in the context of this invention to mean a low-viscosity glycidyl ether of relatively low molecular weight which is compatible with the other composition constituents. It is possible with preference to use, for example, butyl glycidyl ether, ethylhexyl glycidyl ether, phenyl glycidyl ether, glycidyl ethers of Versatic acid, C12/C14 glycidyl ethers, C13/C15 glycidyl ethers, p-tert-butylphenyl glycidyl ether, hexane 1,6-diglycidyl ether, butane 1,4-diglycidyl ether, cyclohexanedimethyl diglycidyl ether, polypropylene diglycidyl ether, polyethylene diglycidyl ether, neopentyl glycol diglycidyl ether, glycerol triglycidyl ether, trimethylolpropane triglycidyl ether and cresyl glycidyl ether.

Auxiliary components usable advantageously are, for example, solvents. Mention should be made, for example, of xylene, hyblene (CAS No. 67774-74-7) or isopropanol. However, the use of solvents in the composition according to the invention is less preferable.

Auxiliary components usable advantageously are, for example, catalysts such as organic acids or tertiary amines. Examples include salicylic acid, tris(N,N-dimethylaminomethyl)phenol, aminoethylpiperazine.

Auxiliary components usable advantageously are, for example, fillers. Examples include sand, silicates, graphite, talc, silicon dioxide.

Auxiliary components usable advantageously are, for example, plasticizers, dyes, pigments, stabilizers, extender resins, deaerators, wetting agents and dispersants, surface additives, substrate wetting agents, ESD additives (ESD=electrostatic discharge), etc.

In the curable compositions according to the invention, it is also advantageously possible to use any desired mixtures of different epoxy resins (1) and/or amine hardeners (2a).

In the curable compositions according to the invention, it is also advantageously possible to use any desired mixtures of different epoxy resins (1) and/or acidic hardeners (2b).

In a particular embodiment of the present invention, it may also be advantageous to use prepolymers of epoxy resins and amine hardeners alone, or in a blend with further epoxy resin and/or amine hardener, in the compositions according to the invention.

In the use of the modifier (3) according to the invention, the user is given every freedom. The modifier (3) according to the invention can be added in the course of production of the curable composition. It is also possible to make prefabricated mixtures of the modifier (3) according to the invention with the epoxy resin (1). In addition, it is also possible to premix the modifier (3) according to the invention with the amine hardener (2a) or the acidic hardener (2b).

Alternatively, rather than monomeric resins or hardeners, it is also possible to mix any desired prepolymers prepared therefrom with the modifier (3) according to the invention. It is possible to add the auxiliary component (4) either to the epoxy resin (1) or to the hardener (2a) or (2b), or else to the modifier (3) according to the invention or else to any desired mixtures of the aforementioned components. In a preferred embodiment, the modifier (3) according to the invention is added to the epoxy resin (1) or to the respective hardeners (2a) or (2b) or is added in the course of production of the curable composition, more preferably to the hardeners (2a) or (2b) or in the course of production of the curable composition.

For a composition which is advantageous in application terms, a particular molar ratio of the epoxy groups of the epoxy resin (1) to the amino groups of the hardener (2a) may be required. In a preferred embodiment of the composition according to the invention, the molar ratio of the epoxy groups of all epoxy resins (1) in the composition to the amino groups of all aminic hardeners (2a) is preferably between 1:0.5 and 1:1.5, more preferably 1:0.7 and 1:1.3, especially preferably 1:0.9 and 1:1.1.

Mixing ratios used of the composition composed of epoxy resin (1), aminic hardener (2a) or acidic hardener (2b), the modifier (3) according to the invention and further auxiliary components (4) are, based on the total weight of the epoxy resin (1) and the aminic hardener (2a), in the preferred embodiment, a mass ratio to the modifier (3) according to the invention of preferably between 1:0 and 1:1, more preferably between 1:0 and 1:0.5, especially preferably between 1:0 and 1:0.2. The mixing ratio based on the total weight of the epoxy resin (1) and the aminic hardener (2a) to further auxiliary components (4) is preferably between 1:0 and 1:15, more preferably 1:0 and 1:8, especially preferably 1:0 and 1:1.

The compositions according to the invention are usable especially advantageously in floor coatings, protective coatings, composites, adhesives and sealants in industrial construction, storage and logistics, construction of administrative buildings and other buildings, water protection, food and drink industry, cleanrooms, park buildings, corrosion protection, concrete protection, sealing of built structures, hygiene coating, other industrial coatings and wall paints. Also included are applications in which the coatings have additional functionalities and properties, for example protection from corrosion, dissipation of electrical current, fire protection.

The subject-matter of the invention is described by way of example hereinafter, without any intention that the invention be restricted to these illustrative embodiments.

### Test Methods:

Parameters or measurements are preferably determined using the methods described hereinbelow. In particular, these methods are used in the examples of the present intellectual property right.

In the context of this invention, weight-average and number-average molecular weights are determined for the benzyl alcohol alkoxylates of the formula (I) prepared by gel permeation chromatography (GPC) calibrated against a polypropylene glycol standard. GPC was conducted using an Agilent 1100 instrument fitted with an RI detector and an SDV 1000/10000 Å column combination consisting of an 0.8×5 cm pre-column and two 0.8×30 cm main columns at a temperature of 30° C. and a flow rate of 1 ml/min (mobile phase: THF). The sample concentration was 10 g/l and the injection volume was 20 pl.

The polydispersity index (PDI) is the quotient of Mw divided by Mn (PDI=Mw/Mn).

The volatile fractions were determined by gas chromatography to DIN EN ISO 11890-2. Before the measurement, the alcoholic end groups were converted to the corresponding trimethylsilyl ethers by derivatization with N-methyl-N-trifluoroacetamide (MSTFA).

The analysis was effected by means of gas chromatography equipped with on-column injection and FID detection. The constituents were separated on an apolar separation column (DB-5 HT; length 30 m; diameter 0.25 mm; film thickness 0.1 μm, temperature program 65° C. to 365° C. at 10° C. per minute, followed by hold time of 15 minutes at 365° C.).

For quantification, the sum total of the peak areas of the constituents classified as VOC/SVOC was determined in comparison to the total peak area of all substances detected in the sample (area % evaluation).

Wet chemistry analysis was performed according to international standard methods: iodine number (IN; DGF C-V 11 a (53); acid number (AN; DGF C-V 2); OH number (ASTM D 4274 C).

The content of primary OH chain termini of the polyethers was determined by the evaluation of quantitative 13C NMR spectra. For this purpose, the intensity of the signals at a shift of ˜62 ppm (primary OH groups) was expressed as a ratio with the signals at ˜67 ppm (secondary OH groups).

The NMR spectra were measured with a Bruker 400 MHz spectrometer using a 5 mm QMP head. Quantitative NMR spectra were measured in the presence of a suitable accelerating agent. The sample to be analyzed was dissolved in a suitable deuterated solvent (methanol) and transferred into 5 mm or, if appropriate, 10 mm NMR tubes.

### EXAMPLE 1

### Synthesis of Benzyl Alcohol-Based Propoxylates and Modifiers According to the Invention

### Examples M1-M14, CM1 and CM2

A 5 liter autoclave is initially charged with the appropriate amount of benzyl alcohol together with 5 mol % of potassium methoxide under nitrogen. The reactor was inertized by injecting nitrogen to 3 bar and then decompressing to standard pressure. This operation was repeated twice more. While stirring, the contents of the reactor were heated to 100° C. and evacuated to about 100 mbar to remove the methanol from the catalysis step. Then the temperature was increased to 120° C. and the alkylene oxide(s) was/were metered in so as to give the distribution of the alkoxy fragments specified in Table 1.

The dosage rate of the alkylene oxide(s) was chosen such that the pressure in the reactor did not rise above 2 bar. After the dosage had ended, there was at first a wait period until the pressure ceased to fall, which was regarded as a sign of virtually quantitative conversion of the alkylene oxide(s). To complete the alkylene oxide conversion, further reaction was conducted for one hour. When the aim is a blockwise alkoxy structure, the above-described procedure is repeated for every pure alkylene oxide to be added on. When the aim is statistical addition of the alkylene oxides, a homogeneous mixture of the respective alkylene oxides is metered in. Finally (after addition of the last alkylene oxide or alkylene oxide mixture with appropriate further reaction), the reaction mixture was deodorized by applying a pressure (p<20 mbar), in order to remove traces of unconverted alkylene oxide. Subsequently, the benzyl alcohol-based alkoxylate was neutralized with dilute phosphoric acid and stabilized with 500 ppm of ANOX 20 AM. Subsequently, the water was removed by distillation under reduced pressure and the precipitated salts were filtered off.

In all cases, colorless to yellowish benzyl alcohol-based alkoxylates were obtained, the essential indices of which are summarized in Table 1. The structure described in the tables which follow is explained as follows: If the alkoxy fragments (for example EO or PO) are separated by a “+”, the structure is a blockwise structure; if the alkoxy fragments are separated by a “/”, the structure is a statistical structure. For simplification of the representation in the tables, the alkoxy fragments were referred to by the alkylene oxides used, EO, PO, BO and SO.

### Example 1a

Acetylation of the modifier M1 according to the invention Under protective gas, a 4 liter three-neck flask equipped with dropping funnel and reflux condenser was initially charged with 1979 g of the modifier 1 together with catalytic amounts of concentrated hydrochloric acid, and heated. Then acetic anhydride was added gradually. On completion of addition, the mixture was stirred at 100° C. for another 4 h. Then acid residues present were distilled off, and a terminally acetylated modifier M1Ac with an acid number of 0.1 and a hydroxyl number of 0 mg KOH/g was obtained.

In an analogous manner, the modifier M5 was also acetylated. This gave a terminally acetylated modifier M5Ac with an acid number of 0.1 and a hydroxyl number of 0 mg KOH/g.

### Example 1b

Methylation of the modifier M1 according to the invention Under protective gas, a 4 liter three-neck flask equipped with a distillation system was initially charged with 1620 g of the modifier M1 according to the invention and heated to 50° C. At this temperature, 130 mol % of sodium methoxide are added gradually. The methanol formed is distilled off. Subsequently, a water-jet vacuum is applied, the temperature is increased to 120° C. and methyl chloride is introduced into the solution with the aid of a gas inlet tube for 1.5 h. After another vacuum distillation step, methyl chloride is again introduced over a period of 1 h. Then the mixture is distilled, neutralized and filtered, and a terminally methylated modifier M1Me with an acid number of 0.1 and a hydroxyl number of 1.0 mg KOH/g is obtained.

In an analogous manner, the modifier M5 was also methylated. This gave a terminally methylated modifier M5Me having an acid number of 0.1 and a hydroxyl number of 2.4 mg KOH/g.

TABLE 1
Structure and physical data of the benzyl alcohol-based alkoxylates

| | | | | Prim. |
|---|---|---|---|---|
| Benzyl alcohol- | | AN | OHN | OH |
| based | | [mg | | termini |
| alkoxylates | Structure | KOH/g] | | [%] |
| M1 | Benzyl alcohol + 3 EO | 0.1 | 220 | 100 |
| M2 | Benzyl alcohol + 6 EO | 0.1 | 147 | 100 |
| M3 | Benzyl alcohol + 3 EO/3 PO | 0.2 | 128 | 14 |
| M4 | Benzyl alcohol + 3 PO + 3 EO | 0.3 | 136 | 74 |
| M5 | Benzyl alcohol + 2 EO/2 PO | 0.3 | 180 | 19 |
| M6 | Benzyl alcohol + 1 EO/5 PO | 0.1 | 132 | 0 |
| M7 | Benzyl alcohol + 2 EO/4 PO | 0.1 | 133 | 0 |
| M8 | Benzyl alcohol + 1 EO/3 PO | 0.1 | 173 | 2 |
| M9 | Benzyl alcohol + 1 PO + 3 EO | 0.1 | 186 | 71 |
| M10 | Benzyl alcohol + 3 EO + 1 PO | 0.1 | 183 | 32 |
| M11 | Benzyl alcohol + 1 EO/3 PO/2 | 0.2 | 118 | 0 |
| | BO | | | |
| M12 | Benzyl alcohol + 1 EO/3 PO/2 | 0.3 | 105 | 0 |
| | SO | | | |
| M13 | Benzyl alcohol + 2 EO/1 PO | 0.2 | 267 | 31 |
| M14 | Benzyl alcohol + 1 EO/2 PO | 0.3 | 270 | 5 |
| M1Ac | Benzyl alcohol + 3 EO, | 0.1 | 0 | 0 |
| | acetylated | | | |
| M5Ac | Benzyl alcohol + 2 EO/2 PO, | 0.1 | 0 | 0 |
| | acetylated | | | |
| M1Me | Benzyl alcohol + 3 EO, | 0.1 | 1 | 100 |
| | methylated | | | |
| M5Me | Benzyl alcohol + 2 EO/2 PO, | 0.1 | 2.4 | 0 |
| | methylated | | | |
| CM1 | Benzyl alcohol + 3 PO | 0.2 | 194 | 0 |
| (comparative | | | | |
| example) | | | | |
| CM2 | Benzyl alcohol + 6 PO | 0.1 | 117 | 0 |
| (comparative | | | | |
| example) | | | | |

M1 to M14 are modifiers according to the invention. CM1 and CM2 are comparative examples.

### EXAMPLE 2

### Outgassing Characteristics

The outgassing characteristics of the inventive modifier M1-12 or of the benzyl alcohol or of the comparative examples is inferred on the basis of the volatile content (VOCs and SVOCs=volatile and moderately volatile organic compounds) in accordance with the definition of DIN EN 11890-2. The volatile fractions are determined by gas chromatography according to DIN EN ISO 11890-2. Before the measurement, the alcoholic end groups were converted to the corresponding trimethylsilyl ethers by derivatization with N-methyl-N-trifluoroacetamide (MSTFA). The analysis was effected by means of gas chromatography equipped with on-column injection and FID detection. The constituents were separated on an apolar separation column (DB-5 HT; length 30 m; diameter 0.25 mm; film thickness 0.1 μm, temperature program 65° C. to 365° C. at 10° C. per minute, followed by hold time of 15 minutes at 365° C.). For quantification, the sum total of the peak areas of the constituents classified as VOC/SVOC was determined in comparison to the total peak area of all substances detected in the sample (area % evaluation). The lower the percentage, the lower the level of volatile substances that are released into the indoor environment.

TABLE 2
Volatile organic content of modifiers according
to the invention compared to benzyl alcohol

| | | Volatile content up |
|---|---|---|
| | | to a boiling point of |
| | | 365° C. |
| | Structure | % |
| Benzyl | Benzyl alcohol | 100 |
| alcohol | | |
| M1 | Benzyl alcohol + 3 EO | 58.6 |
| M2 | Benzyl alcohol + 6 EO | 11.7 |
| M3 | Benzyl alcohol + 3 EO/3 PO | 18.8 |
| M5 | Benzyl alcohol + 2 EO/2 PO | 67.2 |
| M6 | Benzyl alcohol + 1 EO/5 PO | 17.2 |
| M7 | Benzyl alcohol + 2 EO/4 PO | 15.4 |
| M8 | Benzyl alcohol + 1 EO/3 PO | 65.9 |
| M9 | Benzyl alcohol + 1 PO + 3 EO | 60.0 |
| M10 | Benzyl alcohol + 3 EO + 1 PO | 63.7 |
| M11 | Benzyl alcohol + 1 EO/3 PO/2 | 18.4 |
| | BO | |
| M12 | Benzyl alcohol + 1 EO/3 PO/2 | 13.1 |
| | SO | |
| M13 | Benzyl alcohol + 2 EO/1 PO | 61.2 |
| M14 | Benzyl alcohol + 1 EO/2 PO | 61.0 |
| M1Ac | Benzyl alcohol + 3 EO, | 52.3 |
| | acetylated | |
| M5Ac | Benzyl alcohol + 2 EO/2 PO, | 61.6 |
| | acetylated | |
| M1Me | Benzyl alcohol + 3 EO, | 54.7 |
| | methylated | |
| M5Me | Benzyl alcohol + 2 EO/2 PO, | 63.5 |
| | methylated | |
| CM1 | Benzyl alcohol + 3 PO | 65.4 |
| CM2 | Benzyl alcohol + 6 PO | 12.2 |

All modifiers according to the invention are superior to benzyl alcohol in terms of outgassing characteristics. It is additionally found that the inventive M1 compared to CM1 (equal chain length) and the inventive M2 compared to CM2 (equal chain length) release a lower level of volatile organic compounds.

### EXAMPLE 3

### Measurement of Viscosity of the Modifier According to the Invention in Epoxy Resin Binders

The modifier according to the invention is used in epoxy resin binders without catalyst and in epoxy resin binders with catalyst, in order to examine the effect thereof on viscosity.

Formulation I

| | Proportion |
|---|---|
| Epikote 828, binder from Hexion | 20 g |
| M1, M1Ac, M1Me, M2-M5, M5Ac, | 2 g |
| M5Me, M6-M10, M13, M14, CM1-2, | |
| benzyl alcohol | |

Formulation II

| | Proportion |
|---|---|
| Epikote 828, binder from Hexion | 20 g |
| M1-M3, M5-M8, M13, M14, CM1-2, | 2 g |
| benzyl alcohol | |
| Salicylic acid (catalyst) | 0.55 g |

The binder was initially charged in PE cups, the inventive modifier or benzyl alcohol or comparative examples (CM) and optionally catalyst was metered in, and the formulations were each incorporated in a Hauschild Speedmixer at 1000 rpm for 1 min. The viscosities of the formulations were measured with an Anton Paar MCR 102 rheometer. Measurement parameters: cone/plate CP 25/2, 23° C., multiple measurement points in the range of 1-1000 1/s.

TABLE 3.1
Influence of the inventive modifier
on the viscosity of formulation I

| Formula- | | Viscos- | Viscos- | Viscos- |
|---|---|---|---|---|
| tion I | | ity at | ity at | ity at |
| com- | | 10 1/s | 100 1/s | 1000 1/s |
| prising | Structure | mPas | mPas | mPas |
| Benzyl | Benzyl alcohol | 1710 | 1720 | 1670 |
| alcohol | | | | |
| M1 | Benzyl alcohol + 3 EO | 3970 | 3990 | 3690 |
| M1Ac | Benzyl alcohol + 3 EO, | 3940 | 3980 | 3690 |
| | acetylated | | | |
| M1Me | Benzyl alcohol + 3 EO, | 3210 | 3000 | 2890 |
| | methylated | | | |
| M2 | Benzyl alcohol + 6 EO | 4970 | 5040 | 4570 |
| M3 | Benzyl alcohol + 3 EO/3 PO | 5650 | 5710 | 5100 |
| M4 | Benzyl alcohol + 3 PO + 3 | 5877 | 5821 | 5067 |
| | EO | | | |
| M5 | Benzyl alcohol + 2 EO/2 PO | 4470 | 4510 | 4130 |
| M5Ac | Benzyl alcohol + 2 EO/2 | 4330 | 4270 | 3950 |
| | PO, acetylated | | | |
| M5Me | Benzyl alcohol +2 EO/2 | 3910 | 3580 | 3240 |
| | PO, methylated | | | |
| M6 | Benzyl alcohol + 1 EO/5 PO | 5620 | 5630 | 5010 |
| M7 | Benzyl alcohol + 2 EO/4 PO | 4870 | 4890 | 4440 |
| M8 | Benzyl alcohol + 1 EO/3 PO | 3610 | 3660 | 3430 |
| M9 | Benzyl alcohol + 1 PO + 3 | 6104 | 5932 | 5186 |
| | EO | | | |
| M10 | Benzyl alcohol + 3 EO + 1 | 5726 | 5662 | 5034 |
| | PO | | | |
| M13 | Benzyl alcohol + 2 EO/1 PO | 3226 | 3270 | 3142 |
| M14 | Benzyl alcohol + 1 EO/2 PO | 3163 | 3191 | 3073 |
| CM1 | Benzyl alcohol + 3 PO | 4370 | 4410 | 4040 |
| CM2 | Benzyl alcohol + 6 PO | 6280 | 6300 | 5520 |

TABLE 3.2
Influence of the inventive modifier
on the viscosity of formulation II

| Formula- | | Viscos- | Viscos- | Viscos- |
|---|---|---|---|---|
| tion II | | ity at | ity at | ity at |
| com- | | 10 1/s | 100 1/s | 1000 1/s |
| prising | Structure | mPas | mPas | mPas |
| Benzyl | Benzyl alcohol | 2650 | 2640 | 2510 |
| alcohol | | | | |
| M1 | Benzyl alcohol + 3 EO | 5310 | 5310 | 4750 |
| M2 | Benzyl alcohol + 6 EO | 6670 | 6710 | 5820 |
| M3 | Benzyl alcohol + 3 EO/3 | 7080 | 7110 | 6100 |
| | PO | | | |
| M5 | Benzyl alcohol + 2 EO/2 | 6140 | 6180 | 5440 |
| | PO | | | |
| M6 | Benzyl alcohol + 1 EO/5 | 7680 | 7670 | 6480 |
| | PO | | | |
| M7 | Benzyl alcohol + 2 EO/4 | 6850 | 6880 | 5950 |
| | PO | | | |
| M8 | Benzyl alcohol + 1 EO/3 | 6870 | 6900 | 6000 |
| | PO | | | |
| M13 | Benzyl alcohol + 2 EO/1 | 5180 | 5150 | 4520 |
| | PO | | | |
| M14 | Benzyl alcohol + 1 EO/2 | 5320 | 5360 | 4680 |
| | PO | | | |
| CM1 | Benzyl alcohol + 3 PO | 6260 | 6320 | 5530 |
| CM2 | Benzyl alcohol + 6 PO | 7960 | 7950 | 6650 |

### Summary of Tables 3.1 and 3.2:

If the inventive modifier M1 and CM1, having the same chain length, are compared with one another, and analogously the inventive M2, M3, M6 and M7 with CM2 (equal chain length), the modifiers having ethoxy fragments are always superior to the comparative examples with pure PO in terms of the viscosity-lowering effect.

In addition, the viscosity-lowering effect can be enhanced by an end modification. It is apparent from Table 3.1 that the viscosity-lowering effect of the formulation I comprising M1Me or M5Me according to the invention is somewhat better than that of the formulation I comprising the unmodified M1 or M5 according to the invention.

### EXAMPLE 4

### Reaction Rate of Epoxide Hardening

### Assessment of Reactivity of Curable Compositions According to the Invention on the Basis of Doubling of the Viscosity

The doubling of the initial viscosity is a measure of the reaction rate of the epoxy hardening reaction.

### Composition I

| | Proportion |
|---|---|
| Epikote 828, binder from Hexion | 20 g |
| M1, M2, M3, CM1-2, benzyl alcohol | 2 g |
| Vestamin IPD, hardener from Evonik | 4.54 g |
| Resource Efficiency GmbH | |

The binder was initially charged in PE cups, the inventive modifier or benzyl alcohol or comparative examples was metered in, and the mixtures were each incorporated in a Hauschild Speedmixer at 1000 rpm for 1 min. The hardener was weighed in and the curable compositions were stirred in the Speedmixer at 2000 rpm for 1 min. The viscosities of the curable compositions were measured with an Anton Paar MCR 102 rheometer. Measurement parameters: cone/plate 25/2, 23° C., constant shear rate of 100 1/s, measurement lasts until doubling of the start value.

TABLE 4
Influence of the inventive modifier in a curable composition
I on reactivity on the basis of doubling of the viscosity

| Compo- | | Starting | Final | | Prim. |
|---|---|---|---|---|---|
| sition I | | vis- | vis- | | OH |
| com- | | cosity | cosity | Time | termini |
| prising | Structure | mPas | mPas | s | % |
| Benzyl | Benzyl alcohol | 1490 | 2980 | 1790 | 100 |
| alcohol | | | | | |
| M1 | Benzyl alcohol + 3 EO | 1720 | 3440 | 3100 | 100 |
| M2 | Benzyl alcohol + 6 EO | 1710 | 3420 | 3350 | 100 |
| M3 | Benzyl alcohol + 3 EO/3 | 1760 | 3520 | 3580 | 14 |
| | PO | | | | |
| CM1 | Benzyl alcohol + 3 PO | 1720 | 3440 | 3900 | 0 |
| CM2 | Benzyl alcohol + 6 PO | 1870 | 3520 | 3680 | 0 |

If the inventive modifier M1 and CM1 are compared with one another, both having the same chain length, and the inventive M2 and M3 are compared with CM2, curable compositions react more quickly with the inventive modifiers having ethoxy fragments than with those having pure propoxy fragments.

### EXAMPLE 5

### Curing

### Influence of the Inventive Modifier in a Curable Composition on Hardening

For the testing of Shore D hardness, the formulation of curable composition I was used.

The binder was initially charged in PE cups, the inventive modifier was metered in, and the mixtures were each incorporated in a Hauschild Speedmixer at 1000 rpm for 1 min. The hardener was weighed in and the curable compositions were stirred in the Speedmixer at 2000 rpm for 1 min. This was used to cast a slab of layer thickness about 5 mm. The Shore D hardnesses were measured after various intervals.

TABLE 5
Evolution of Shore D hardness of curable
compositions according to the invention

| | | Shore D | Shore D |
|---|---|---|---|
| | | hardness | hardness |
| | | after 2 | after 7 |
| Composition | | days | days |
| I comprising | Structure | Shore | Shore |
| Benzyl | Benzyl alcohol | 86.3 | 88.6 |
| alcohol | | | |
| M1 | Benzyl alcohol + 3 EO | 86.2 | 88.7 |
| M1Ac | Benzyl alcohol + 3 EO, | 83.9 | 88.9 |
| | acetylated | | |
| M1Me | Benzyl alcohol + 3 EO, | 83.8 | 87.5 |
| | methylated | | |
| M2 | Benzyl alcohol + 6 EO | 84.4 | 88.4 |
| M3 | Benzyl alcohol + 3 EO/3 PO | 84.5 | 85.9 |
| M5 | Benzyl alcohol + 2 EO/2 PO | 85.1 | 88.1 |
| M5Ac | Benzyl alcohol + 2 EO/2 PO, | 83.2 | 88.0 |
| | acetylated | | |
| M5Me | Benzyl alcohol + 2 EO/2 PO, | 83.6 | 87.9 |
| | methylated | | |
| M6 | Benzyl alcohol + 1 EO/5 PO | 85.2 | 87.6 |
| M7 | Benzyl alcohol + 2 EO/4 PO | 85.0 | 87.5 |
| M8 | Benzyl alcohol + 1 EO/3 PO | 82.3 | 87.1 |
| M9 | Benzyl alcohol + 1 PO + 3 EO | 83.7 | 87.0 |
| M10 | Benzyl alcohol + 3 EO + 1 PO | 85.9 | 87.0 |
| M11 | Benzyl alcohol + 1 EO/3 PO/2 | 83.3 | 86.8 |
| | BO | | |
| M12 | Benzyl alcohol + 1 EO/3 PO/2 | 82.6 | 85.9 |
| | SO | | |
| M13 | Benzyl alcohol + 2 EO/1 PO | 86.5 | 89.6 |
| M14 | Benzyl alcohol + 1 EO/2 PO | 87.2 | 89.6 |
| CM1 | Benzyl alcohol + 3 PO | 78.6 | 88.7 |
| CM2 | Benzyl alcohol + 6 PO | 81.6 | 87.4 |

Curable compositions comprising the modifiers according to the invention show comparable evolution of heat after 2 days to the composition comprising benzyl alcohol. CM1 and CM2 having propoxy fragments are distinctly inferior in terms of initial hardness.

### EXAMPLE 6

### Moisture Sensitivity

A measure used for the moisture sensitivity of an epoxy coating is the tendency to carbamate formation. For this purpose, a small piece of sponge is soaked with water, the sponge is placed onto the coating and a bull's-eye (glass hemisphere) is mounted above it. The surface is assessed at intervals. The carbamate formed on the surface has a whitish appearance. Assessment is made on a scale from 1 (very significant carbamate formation) to 5 (no carbamate formation).

Curable composition II for production of the epoxy coating

| | Proportion |
|---|---|
| Epikote 828, binder from Hexion | 20 g |
| M1, 2, 3, 5-14, CM1-2, benzyl alcohol | 1 g |
| Vestamin IPD, hardener from Evonik | 4.54 g |
| Resource Efficiency GmbH | |

The binder was initially charged in PE cups, the inventive modifier or benzyl alcohol or comparative examples was metered in, and the mixtures were each incorporated in a Hauschild Speedmixer at 1000 rpm for 1 min. The hardener was weighed in and the curable compositions were stirred in the Speedmixer at 2000 rpm for 1 min. This was used to cast a slab of layer thickness about 5 mm. Carbamate formation was assessed after 1, 2 and 7 days.

TABLE 6
Carbamate formation on a coating comprising inventive
modifiers compared to benzyl alcohol

| Composition | | | | |
|---|---|---|---|---|
| II | | after | after | after |
| comprising | Structure | 1 d | 2 d | 7 d |
| Benzyl | Benzyl alcohol | 5 | 5 | 5 |
| alcohol | | | | |
| M1 | Benzyl alcohol + 3 EO | 5 | 5 | 5 |
| M1Ac | Benzyl alcohol + 3 EO, | 3 | 3 | 3 |
| | acetylated | | | |
| M1Me | Benzyl alcohol + 3 EO, | 2 | 2 | 3 |
| | methylated | | | |
| M2 | Benzyl alcohol + 6 EO | 1 | 4 | 5 |
| M3 | Benzyl alcohol + 3 EO/3 PO | 2 | 4 | 4 |
| M5 | Benzyl alcohol + 2 EO/2 PO | 1 | 2 | 5 |
| M5Ac | Benzyl alcohol + 2 EO/2 PO, | 2 | 3 | 3 |
| | acetylated | | | |
| M5Me | Benzyl alcohol + 2 EO/2 PO, | 2 | 2 | 3 |
| | acetylated | | | |
| M6 | Benzyl alcohol + 1 EO/5 PO | 3 | 4 | 5 |
| M7 | Benzyl alcohol + 2 EO/4 PO | 3 | 3 | 5 |
| M8 | Benzyl alcohol + 1 EO/3 PO | 2 | 4 | 4 |
| M9 | Benzyl alcohol + 1 PO + 3 EO | 5 | 5 | 5 |
| M10 | Benzyl alcohol + 3 EO + 1 PO | 5 | 5 | 5 |
| M11 | Benzyl alcohol + 1 EO/3 PO/2 | 3 | 3 | 3 |
| | BO | | | |
| M12 | Benzyl alcohol + 1 EO/3 PO/2 | 3 | 2 | 3 |
| | SO | | | |
| M13 | Benzyl alcohol + 2 EO/1 PO | 5 | 5 | 5 |
| M14 | Benzyl alcohol + 1 EO/2 PO | 3 | 4 | 4 |
| CM1 | Benzyl alcohol + 3 PO | 2 | 2 | 3 |
| CM2 | Benzyl alcohol + 6 PO | 1 | 2 | 3 |

Coatings comprising inventive modifiers with ethoxy fragments show comparable moisture sensitivity to the coating comprising benzyl alcohol. Comparative examples comprising propoxy fragments only are distinctly inferior.

1. A modifier comprising benzyl alcohol-based alkoxylates for curable compositions comprising one epoxy resin and one hardener, wherein the benzyl alcohol-based alkoxylate is obtained by reacting benzyl alcohol with alkylene oxides, wherein the benzyl alcohol-based alkoxylate having at least one ethoxy fragment.

2. The modifier according to claim 1, wherein the benzyl alcohol-based alkoxylate comprises benzyl alcohol-based ethoxylates or benzyl alcohol-based mixed alkoxylates of the formula (I) 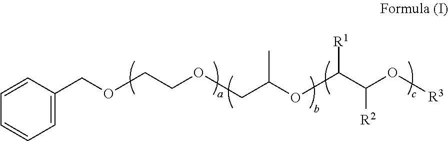
where
a=alkoxy fragment (a)=1 to 10,
b=alkoxy fragment (b)=0 to 10,
c=alkoxy fragment (c)=0 to 10,
R1, R2=independently hydrogen, an alkyl group having 2 to 20 carbon atoms, an aryl or alkaryl group, with the proviso that R1 is not H when R2 is methyl, and that the two R1 and R2 radicals must not both be H at the same time,
R3=independently a hydrogen radical, an acetyl, phosphoric ester or alkyl group which has 1 to 20 carbon atoms and may also have further substitution.

3. The modifier according to claim 2, wherein the alkylene oxides are selected from the group consisting of-ethylene oxide (EO), propylene oxide (PO), 1,2-epoxy-2-methylpropane (isobutylene oxide), epichlorohydrin, 2,3-epoxy-1-propanol, 1,2-epoxybutane (butylene oxide, BO), 2,3-epoxybutane, 2,3-dimethyl-2,3-epoxybutane, 1,2-epoxypentane, 1,2-epoxy-3-methylpentane, 1,2-epoxyhexane, 1,2-epoxycyclohexane, 1,2-epoxyheptane, 1,2-epoxyoctane, 1,2-epoxynonane, 1,2-epoxydecane, 1,2-epoxyundecane, 1,2-epoxydodecane, styrene oxide (SO), 1,2-epoxycyclopentane, 1,2-epoxycyclohexane, vinylcyclohexene oxide, (2,3-epoxypropyl)benzene, vinyloxirane, 3-phenoxy-1,2-epoxypropane, 2,3-epoxy methyl ether, 2,3-epoxy ethyl ether, 2,3-epoxy isopropyl ether, 3,4-epoxybutyl stearate, 4,5-epoxypentyl acetate, 2,3-epoxypropane methacrylate, 2,3-epoxypropane acrylate, glycidyl butyrate, methyl glycidate, ethyl 2,3-epoxybutanoate, 4-(trimethylsilyl)butane 1,2-epoxide, 4-(triethylsilyl)butane 1,2-epoxide, 3-(perfluoromethyl)-1,2-epoxypropane, 3-(perfluoroethyl)-1,2-epoxypropane, 3-(perfluorobutyl)-1,2-epoxypropane, 3-(perfluorohexyl)-1,2-epoxypropane, 4-(2,3-epoxypropyl)morpholine, 1-(oxiran-2-ylmethyl)pyrrolidin-2-one.

4. The modifier according to claim 3, wherein the alkylene oxides are used individually or in any desired mixtures for alkoxylation of the benzyl alcohol.

5. The modifier according to claim 4, wherein the benzyl alcohol-based mixed alkoxylate is prepared by reacting ethylene oxide (EO) and propylene oxide (PO) in a molar ratio of 1:10 to 10:0.

6. The modifier according to claim 5, wherein the alkoxy fragments (a) and (b) may be added onto the benzyl alcohol in statistical or random distribution.

7. The modifier according to claim 2, wherein the degree of alkoxylation is 3 to 10.

8. The modifier according to claim 2, wherein the benzyl alcohol-based alkoxylate has a terminal hydroxyl group.

9. The modifier according to claim 1, wherein the terminal hydroxyl group of the benzyl alcohol-based alkoxylate is acetylated, methylated or phosphorylated.

10. The modifier according to claim 2, wherein the polydispersity (Mw/Mn) of the benzyl alcohol-based mixed alkoxylates of formula (I) is <2.5, determined by means of GPC.

11. A method of making a benzyl alcohol-based alkoxylates comprising the steps of mixing at least one epoxy fragment as modifiers for curable compositions comprising at least one epoxy resin, and at least one hardener, and further auxiliary components.

12. The method according to claim 11 of formula (I) 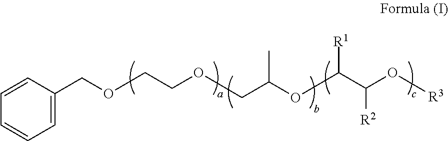
where
a=alkoxy fragment (a)=1 to 10,
b=alkoxy fragment (b)=0 to 10,
c=alkoxy fragment (c)=0 to 10,
R1, R2=independently hydrogen, an alkyl group having 2 to 20 carbon atoms, an aryl or alkaryl group, with the proviso that R1 is not H when R2 is methyl, and that the two R1 and R2 radicals must not both be H at the same time,
R3=independently a hydrogen radical, an acetyl, phosphoric ester or alkyl group which has 1 to 20 carbon atoms and may also have further substitution.

13. A curable composition comprising
(1) at least one epoxy resin,
(2) at least one hardener,
(3) at least one modifier according to claim 1, and
(4) further auxiliary components.

14. The curable composition according to claim 13, wherein bisphenol A diglycidyl ether-based epoxy resins or bisphenol F diglycidyl ether-based epoxy resins are used.

15. The curable composition according to claim 14, wherein the at least one hardener (2) is an aminic hardener selected from the group consisting of aliphatic, cycloaliphatic, araliphatic or aromatic amines or polyamines.

16. The curable composition according to claim 15, wherein the at least one hardener (2) is an acidic hardener selected from the group consisting of acids and acid anhydrides.

17. A method of making floor coatings, paints, polymer concrete, repair systems, anchoring compounds, adhesives, potting compounds and impregnations, fiber composite materials comprising the step of mixing the curable composition of claim 13 with other ingredients to prepare floor coatings, paints, polymer concrete, repair systems, anchoring compounds, adhesives, potting compounds and impregnations, fiber composite materials.

18. The method of claim 11, wherein the at least one hardener is an aminic hardener selected from the group consisting of aliphatic, cycloaliphatic, araliphatic or aromatic amines or polyamines.

19. The method of claim 11, wherein the at least one hardener is an is an acidic hardener selected from the group consisting of acids and acid anhydrides.

20. The modifier according to claim 1, wherein the benzyl alcohol-based alkoxylate comprises benzyl alcohol-based ethoxylates or benzyl alcohol-based mixed alkoxylates of the formula (I) 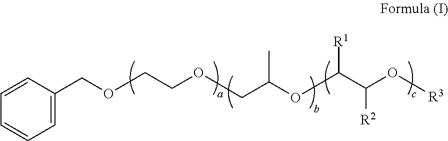
where
a=alkoxy fragment (a)=2 to 7,
b=alkoxy fragment (b)=1 to 7,
c=alkoxy fragment (c)=0 to 6,
R1, R2=independently hydrogen, ethyl, octyl, decyl or phenyl group, with the proviso that R1 is not H when R2 is methyl, and that the two R1 and R2 radicals must not both be H at the same time,
R3=independently a hydrogen radical.
